(19) United States
(12) Patent Application Publication
(10) Pub. No.: US 2008/0082402 A1
(43) Pub. Date: Apr. 3, 2008

(54) Advertisement server for wireless access points

(75) Inventor: Blake Turrentine, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ParanormalResearch.com, San Francisco, CA (US)

(21) Appl. No.: 11/524,346

(22) Filed: Sep. 19, 2006

(51) Int. Cl. G06Q 30/00

(52) U.S. Cl. 705/14

(57) ABSTRACT

A local advertising system provides wireless network access and advertisements to users. The local advertising system includes a connection with a wide-area network, such as the internet, and with a local-area network, which connects with users. The local advertising system intercepts network communications between users and the wide-area network. The local advertising system adds advertisements to users' network communications. Upon receiving a request for a network resource, such as a web page, the local advertising system determines whether the user should receive an advertisement. If so, the local advertising system selects and presents an advertisement appropriate for the user. Upon termination of the advertisement, the local advertising system provides the requested network resource to the user. The local advertising system may retrieve and cache requested network resources while the advertisement is presented to the user, and then provide the cached network resources to the user upon termination of the advertisement.

### BACKGROUND OF THE INVENTION

This invention relates to providing advertisements and other content in conjunction with network access in a wireless access configuration. With the advent of wireless networking technology, users are able to connect to the internet through a variety of devices such as laptops, personal digital assistants (PDAs), and mobile telephones, to name a few. These consumer wireless products connect via a wireless network connection, colloquially known as a wireless hotspot. A hotspot is a physical area in which wireless network access to the internet is provided to devices.

As the number of wireless devices has increased, so too has demand increased for wireless access. This demand has created an incentive for a variety of business owners to offer wireless access on their premises. The need to offer access is prompted, in-part, by the need to attract customers and remain competitive in a mobile world. As more and more businesses offer wireless access as an amenity, competitors will need to do the same or risk losing customers. In addition to being competitive, wireless access also provides an additional source of revenue.

In some cases, business owners charge an additional fee to its customers to use their wireless network connections. This fee covers all or a portion of the cost of installing and maintaining the wireless network connection. The wireless network access fee may be collected directly by the business owner or by a wireless network provider that sells access to one or more hotspots.

In other cases, businesses provide free wireless access on its premises to attract customers. In these applications, the business owner hopes the additional business attracted by the wireless network connection offsets the costs to install and maintain wireless network access.

Fee-based wireless access often discourages casual users from using wireless network connections. As a result, fee-based wireless access often provides very little increased business. Additionally, the number of paying users for a business establishment may be so small that a competitive fee cannot cover the cost of the service. Although free wireless access attracts many more users, even the increased business provided by these users may not offset the business owner's wireless access costs.

As a solution to this problem, some businesses have begun to include advertising in their wireless network access. Previous wireless access schemes have used a server located at a central location to provide advertisements to hotspots at numerous different locations. This approach has numerous drawbacks. First, advertisements provided by a central server are not typically tailored to the local demographics of individual hotspots. Additionally, it is difficult for a business owner to include local advertising content in their wireless access. Moreover, because advertisements are sent from a central server to the hotspot user over the internet, each advertisement incurs a cost both in terms of network bandwidth and time delay. The time delay for sending advertisements is particularly frustrated to users, decreasing the effectiveness of the advertisements. Moreover, the network bandwidth restrictions often limit the type of content that can be included in advertisements. Video, music, and animations are often too large to be used in advertisements without incurring substantial data transfer delays.

Therefore, it is desirable to have a wireless internet access system that provides improved advertising to users. It is further desirable to tailor the advertising to customer and local preferences so as to increase the effectiveness of the advertisements and generate more revenue per ad. It is further desirable to provide advertisements to users with less time delay and a wide variety of content without incurring substantial bandwidth costs. It is also desirable to offer virtual networks, or network channels, containing content specific internet programming and advertisements to appeal to the consumer.

### BRIEF SUMMARY OF THE INVENTION

An embodiment of the invention includes a local advertising server system for providing wireless network access and advertisements to users. In an embodiment, the local advertising server system includes a connection with a wide-area network, such as the internet, and with a local-area network, which is used to connect with network users. The local-area network includes one or more wireless networking devices to provide wireless network connections to network users. In an embodiment, the local advertising server system intercepts network communications between network users and the wide-area network. The local advertising server system adds advertisements to users network communications.

In an embodiment, upon receiving a request for a network resource, such as a web page, the local advertising server system determines whether the network user should receive an advertisement. If so, the local advertising server system analyzes network user activity and other profile information to select an advertisement appropriate for the user. The selected advertisement is presented to the user. In an embodiment, the advertisement is a separate web page including text, audio, graphics, animation, and/or interactive elements. Upon termination of the advertisement, which may occur upon request by a user or after a time period or other condition, the local advertising server system provides the requested network resource to the network user. In an embodiment, the local advertising server system retrieves and caches the requested network resource while the advertisement is being presented to the network user, and then provides the cached network resource to the network user upon termination of the advertisement.

### BRIEF DESCRIPTION OF THE DRAWINGS

This invention will be described with reference to the drawings, in which:

FIG. 1 is a diagram of a wireless network connection system employing an embodiment of the invention;

FIG. 2 illustrates a method of providing advertisements to users according to an embodiment of the invention; and

FIG. 3 illustrates a computer system suitable for implementing an embodiment of the invention.

### DETAILED DESCRIPTION OF THE INVENTION

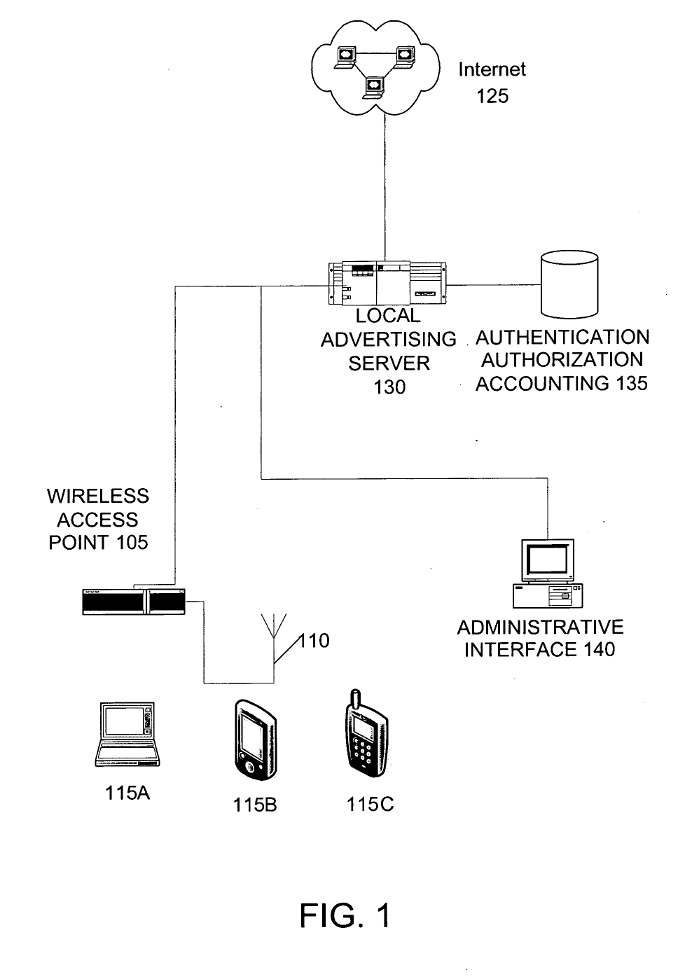

FIG. 1 is a diagram of a wireless network connection system 100 employing an embodiment of the invention. System 100 includes one or more wireless access points 105. Wireless access point 105 is adapted to provide a wireless network connection with one or more devices 115, such as computer 115a, PDA 115b, and network-capable telephone 115c. Wireless access point 105 communicates with devices 115 using one or more antennas 110. Antenna 110 may be an omni-directional antenna adapted to blanket a large area with wireless network access or a uni-directional antenna adapted to focus network access on a particular region. Wireless access point 105 can utilize any type of wireless data communications technique and/or protocol known in the art, including standard wireless protocols such as the IEEE 802.11 family of wireless networking protocols and proprietary or non-standard wireless networking protocols. With the use of a switch or other networking devices, a number of WAPs can be established in a location to provide full coverage of the intended broadcast area as well as adequately provide for the number of users in a given area.

The wireless access point 105 connects with the internet 125 (or any other wide-area network) via a local advertising server 130. In an embodiment, one of the functions of the local advertising server 130 is to operate as a bridge, router, firewall, switch, and/or network address translator (NAT). These functions allow the local advertising server 130 to occupy any part of the network. Further, the connection between the internet 125 and the local advertising server 130 may be isolated to protect other devices from internet attacks. This isolation is called a demilitarized zone (DMZ), and it is managed by the local advertising server 130.

In system 100, the local advertising server 130 functions as a router to provide a DMZ between the hotspot. In alternate embodiments, the local advertising server 130 may be operated in conjunction with a dedicated router, firewall, switch, and/or network address translator, enabling the local advertising server 130 to be located in different locations within the system 100 and to connect with multiple wireless access points 105 and other devices.

The primary function of the local advertising server 130 is to control access to the internet 125 by user devices 115 and to distribute advertisements to the devices 115 as necessary. In an embodiment, the local advertising server 130 supports a variety of network protocols such as static IP, DHCP (server and relay), and PPPoE. Also, the local advertising server 130 may act as a proxy server, a virtual server, and an SMTP redirector. Additionally, IP plug and play (IP PnP) as well as inter-IP segment roaming is also supported. These network connections allow for a variety of devices to connect to the local advertising server 130 and communicate with the internet. Server authentication protocols that are supported include POP3, LDAP, and Windows Domain Server.

As discussed in detail below, an embodiment of the local advertising server 130 periodically interrupts a users interactions with the internet to present advertisements. These advertisements may take the form of “commercials” or other short presentations inserted between web pages requested by the user. Following the commercials, the local advertising server 130 presents users with their requested web pages. In other embodiments, the advertisements are added to web pages requested by users, such as a banner ad on the requested web page or in a frame surrounding the requested web page.

In an embodiment, the commercials and other advertisements are hosted by the local advertising server 130, rather than being provided by a central advertisement server. As a result, the advertisements do not have to be communicated over broadband network connection 145 from the internet 125 to devices 115, saving network bandwidth and reducing time delays in retrieving advertisement content. Furthermore, because the local advertising server 130 is local to the devices 115, it is easy to tailor advertisements to local demographics and businesses. Additionally, because all network traffic between devices 115 and the internet 125 pass through the local advertising server 130, the local advertising server 130 can monitor the users' preferences and tailor advertising to their interests.

Moreover, because all network traffic between devices 115 and the internet 125 pass through the local advertising server 130, the local advertising server 130 can provide advertisements to users independent of which network resources the user requests. For example, local advertising server 130 can provide an advertisement to a user when he or she leaves a first web site and travels to a second web site, even if the first and second web sites are unaffiliated. In this embodiment, the local advertising server 130 provides advertising to users without requiring cooperation or permission from any network resource or server hosting network resources. Because of this, the advertising provided by the local advertising server 130 is said to be network resource independent.

The local advertising server 130 connects with the internet 125 using a high-speed wired or wireless network connection. Although not shown, other intermediary devices may be connected between the internet 125 and the local advertising server 130. Such devices may facilitate the network connection between the internet 125 and the local advertising server 130. For example, a cable modem, DSL modem, or fiber-optic network adapter may provide the network connection from the internet to the local advertising server 130.

The local advertising server 130 also provides a number of other connection points for user access. This access, for example, permits the user to configure the local advertising server 130, perform updates, and upload data and advertisements. Such connections may consist of serial connection ports, USB ports, wired network connections or other suitable connections. For example, administrative terminal or computer 140 enables the local advertising server 130 to be monitored and updated.

Another connection on the local advertising server 130 is for the authentication authorization and accounting (AAA) server. The AAA server provides the local advertising server 130 with a means to log the identity of the user as well as provide a filter by preventing automated malicious attackers. The AAA server may be any type of authentication server. In an embodiment, it is a remote authentication dial-in service (RADIUS) server. The RADIUS server tracks such attributes as start time and end time of the session, user ID, user MAC, user IP, the number of packets in and out, the number of bytes in and out, the calling station ID, among others. The RADIUS server uses password authentication protocol (PAP) as well as challenge handshake authentication protocol (CHAP).

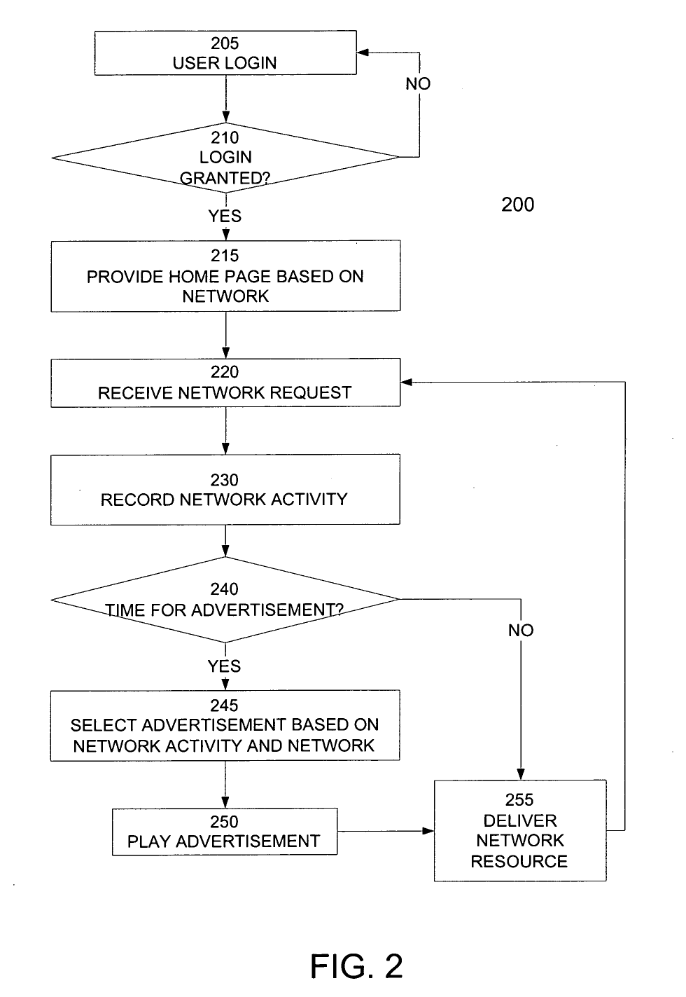

FIG. 2 illustrates a method 200 of providing advertisements to users according to an embodiment of the invention. In an embodiment, the local advertising server, via a wireless access point, receives a user login request in step 205. In an embodiment, the local advertising server and wireless access point maintains a number of different virtual networks or channels. Each virtual network or channel can present a different branded identity to users. For example, a local advertising server and associated wireless access points could be configured to provide different virtual networks to different nearby businesses. A hotel may be provided with a “Hotel” virtual network and a coffee shop may be provided with a “Coffee Shop” virtual network. Although each of these virtual networks may be handled by the same local advertising server, to users, it appears as if these virtual networks are separate and independent. In another example, virtual networks may be branded based on specific content, such as a sports network, a children's network, an adult entertainment network, or a gambling network. In an embodiment, an SSID or other identifying network name is provided for each virtual network to indicate its identity. A user selects a virtual network by its SSID to request a login for the network connection.

Upon receiving a user login request, step 205 collects login information from a user. The login information may include a user name, e-mail address, password, and/or consent to terms of service. In a further embodiment, step 205 may use a CAPTCHA, which is a test to distinguish between human and computer users, to prevent automated devices from logging in to the network without a human user's explicit direction and from abusing the network connection. An example of a CAPTCHA displays distorted text or numbers and asks the user to recognize and type this text.

Step 210 analyzes the information entered by the user to determine whether to grant access to the user. Additionally, step 210 may store the user login information for identification and user monitoring purposes. It is also used to prevent unwanted users from having access to the networks. Since, these virtual networks are typically free and generate revenue by encouraging users to connect, the login information will typically only be used to for identification purposes, such as tracking user preferences and determining when to provide the user with an advertisement to view.

After the login has been granted to the user, step 215 transmits the home page for the virtual network selected by the user to the user. The home page may be tailored to the type of virtual network selected by the user. For example, a sports-themed virtual network home page may include sports information and links, while a coffee shop virtual network home page may include information about the coffee shop.

Step 220 receives a request from a user for a network resource. In an embodiment, the network resource includes a web page identified by a URL. In some implementations, step 220 determines if the selected virtual network is configured to restrict user access to some network resources. If so, step 220 determines if the network request should be blocked. If not, or if the selected virtual network is unrestricted, then step 220 will begin the retrieval of the requested network resource. In an embodiment, step 220 may retrieve and cache the network resource in the background while steps 230, 240, 245, and 250 are being performed.

Step 230 records the network activity. In an embodiment, step 230 records the user identity and the identity of the requested network resource. In a further embodiment, step 230 may record additional information, such as search terms entered by the user into a search engine web page. The stored network activity information, along with parameters of the local advertising server, are used to determine an appropriate advertisement to present to the user.

Step 240 determines if it is time to present an advertisement to a user. In an embodiment, a counter or time stamp is recorded for each user to track the time elapsed since the user has seen an advertisement. The local advertising server is configured to present advertisements at specified time intervals. If the network request has been received in step 220 following the expiration of the specified time interval, then step 240 indicates that it is time for another advertisement. Otherwise, method 200 proceeds to step 255. Different virtual networks may have different time interval values for providing advertisements at different frequencies. For example, a company intranet may use a virtual network and have no advertisements, a virtual network for hotel guests may have moderate advertisements, and a virtual network for a hotel lobby may have frequent advertisements. All of these virtual networks can be operated using the same local advertising server.

Step 245 selects an appropriate advertisement for the user. In an embodiment, step 245 uses the recorded network activity to determine the user's interests, and then matches these interested with one or more advertisements. In a further embodiment, the user's selection of a virtual network also influences the selection of advertisements. For example, a user accessing an adult entertainment virtual network will be presented with adult entertainment advertisements. In a further embodiment, the local demographics and environment associated with the local advertisement server will influence the selection of advertisements. For example, users of a coffee shop virtual network in a coffee shop will receive advertisements related to the coffee shop or nearby businesses and services.

An appropriate advertisement is determined by several factors. First, the administrator of the local advertising server has the option to have a virtual network specific advertisement delivered. This is an advertisement tied to the particular virtual network that the user is currently accessing. Thus, at regular intervals, the local advertising server can distribute advertisements to all users on a first virtual network. This advertisement will contain links to similar virtual networks that users of the first virtual network might want.

Second, the local advertising server can deliver virtual network generic advertisements. These are advertisements that are not directed to any particular users, but rather all users on a particular virtual network. These advertisements are each associated with an attribute file. The attribute file contains the pre-set parameters that determine, in-part, when and to whom the advertisement is delivered. These attributes are selected by the owner of the advertisement.

The attribute file for each advertisement contains the individual parameters that control delivery. The owner of the advertisement can select the different virtual networks that the advertisement will be broadcast. The status of the advertisement can be selected. This allows an advertisement to be deactivated for a period of time but not deleted. Priority of the advertisement can be set. The starting and ending dates for each advertisement are also set, and when an advertisement reaches the end date, it is deactivated. Yet another setting is the mode. An owner may select mixed or fresh. A mixed mode operation allows the advertisement to be incorporated into the content of the requested resource, such as in the form of a banner or frame. In contrast, fresh mode operation allows for the advertisement to appear on a separate page. Another setting in the attribute file is the name or keyword. The keyword is a term that is used to match the advertisement with a particular term that has been entered by the user. Next, the advertisement duration is selected. The duration is the time for completion of the advertisement. Also, the advertiser can enter the maximum or minimum number of times for the advertisement to be transmitted. Finally, the user selects the time and virtual network that the advertisement will be delivered. Optionally, the advertiser may select a random delivery.

Regardless whether a random delivery is chosen or a specific time and virtual network is chosen, the priority attribute will need to be selected. By setting the priority, if two or more advertisements otherwise have the same attributes, the advertisement with the highest priority will be displayed.

A third type of advertisement use comprises delivery of user specific advertisements. User specific advertisements are those types of advertisements that are delivered to the user based on the user's preferences. Such preferences can be determined from the web pages that the user visits (called surfing). Preferences may also be culled from the search terms that are input by the user when utilizing a search routine. Further, client request caching, secured socket layer (SSL) sessions, and cookies may also be used to establish a profile for the user. This profile is then matched to the attributes on the attribute files. For example, when a user requests a URL, the key terms from the site are stored and matched to the keyword field in the attribute files. If there is a match, the advertisement will be delivered. If no match occurs, the local advertising server 130 will determine, based on other criteria, the advertisement to display.

Step 250 presents the advertisement to the user. In an embodiment, the advertisement is sent to the user in response to their network resource request. The advertisement will be in a format compatible with their applications, such as a web browser. The advertisement can include text; still pictures or animation; audio; and interactive content, such as a game, puzzle, or activity. Advertisements may be of a variety of file types including .php, .png, .swf, HTML, .avi, jpg, giff, .mov, tiff, .asx, and others. In addition, the advertisements may be displayed as part of a grid containing multiple advertisements, the advertisements may be encapsulated with a wrapper of other advertisements, and the advertisement may be a dedicated page. The advertisement may also include one or more hyperlinks for more information on purchasing the goods or services mentioned in the advertisement.

Once the advertisement is being displayed, the option exists to either force the user to view the advertisement or let the user terminate the advertisement. In an embodiment, the advertisement includes program code, such as javascript or another scripting language, that contacts the local advertising server when the advertisement is complete. Regardless, when the advertisement is complete, step 255 delivers the network resource originally requested by the user to the user's device. In an embodiment, step 255 retrieves the requested network resource from a cache. As discussed above, the network resource is retrieved in the background and stored in the cache while the user's requested URL is delivered from cache memory. However, if the advertisement allows the user to select a URL, the local advertising server 130 then redirects the user to the selected URL embedded within the advertisement.

In a further embodiment, the local advertising server may be used to cache web pages for public service messages such as Amber Alerts, weather alert, evacuation announcements, or other such messages. In regard to emergency messages, these pages will be cached locally on the local advertising server in order to provide information in the event of a disaster. That is, if traditional communication links are disrupted, users with battery operated mobile devices will be able to connect to a local advertising server to be informed. If the local advertising server has emergency back up power, it will be able to transmit emergency messages cached locally despite a lack of connectivity to the internet or power.

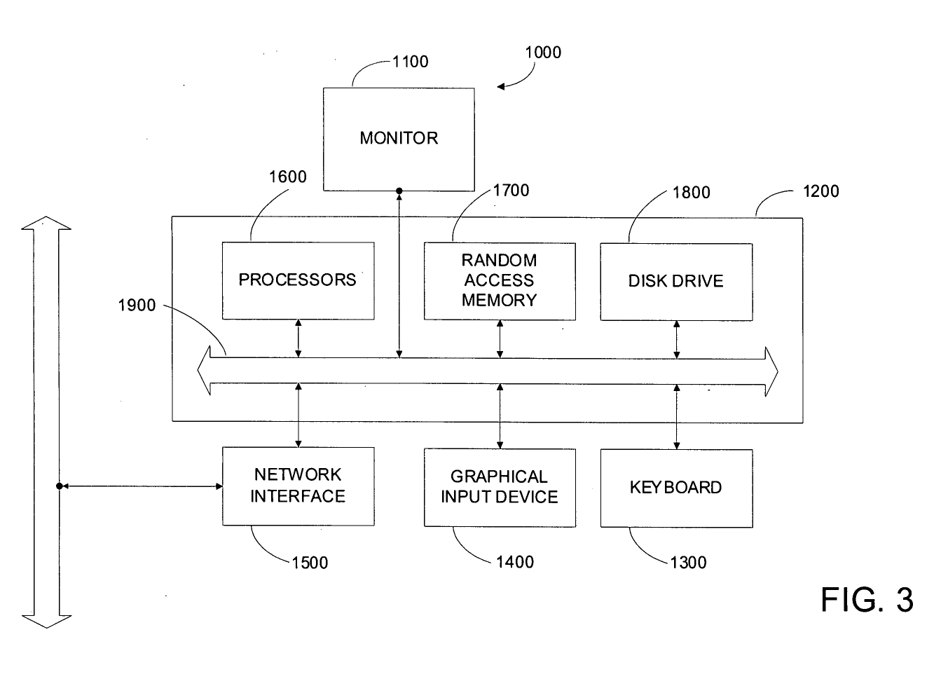

FIG. 3 illustrates a computer system 1000 suitable for implementing an embodiment of the invention. Computer system 1000 typically includes a monitor 1100, computer 1200, a keyboard 1300, a user input device 1400, and a network interface 1500. User input device 1400 includes a computer mouse, a trackball, a track pad, graphics tablet, touch screen, and/or other wired or wireless input devices that allow a user to create or select graphics, objects, icons, and/or text appearing on the monitor 1100. Embodiments of network interface 1500 typically provides wired or wireless communication with an electronic communications network, such as a local area network, a wide area network, for example the Internet, and/or virtual networks, for example a virtual private network (VPN). In an embodiment, computer system 1000 includes a network connection with a wide-area network, such as the Internet, and a second network connection with a local-area network.

Computer 1200 typically includes components such as one or more general purpose processors 1600, and memory storage devices, such as a random access memory (RAM) 1700, disk drives 1800, and system bus 1900 interconnecting the above components. RAM 1700 and disk drive 1800 are examples of tangible media for storage of data, audio/video files, computer programs, applet interpreters or compilers, virtual machines, and embodiments of the herein described invention. Other types of tangible media include floppy disks; removable hard disks; optical storage media such as DVD-ROM, CD-ROM, and bar codes; non-volatile memory devices such as flash memories; read-only-memories (ROMS); battery-backed volatile memories; and networked storage devices.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for providing advertising to network users, the system comprising:
a network interface configured to connect with at least one network user via a local-area network and to connect the system with a wide-area network, wherein the network interface includes logic adapted to direct a network resource request from the network user for a network resource provided by the wide-area network to the system;
logic adapted to determine if an advertisement should be provided to the network user;
logic adapted to select an advertisement in response to the determination that an advertisement should be provided to the network user;
logic adapted to communicate the advertisement to the network user;
logic adapted to retrieve the network resource provided by the wide-area network;
logic adapted to detect the termination of the advertisement; and
in response to the termination of the advertisement, logic adapted to communicate the network resource with the network user.

2. The system of claim 1, wherein the logic adapted to direct a network resource request from the network user for a network resource includes logic adapted to determine network preferences for the network user based on the network resource request and to store the network preferences.

3. The system of claim 2, wherein the logic adapted to select an advertisement includes logic adapted to retrieve the stored network preferences for the network user and to select an advertisement from a stored set of advertisements based upon the retrieved network preferences.

4. The system of claim 1, wherein the logic adapted to retrieve the network resource includes logic adapted to cache the network resource and wherein the logic adapted to communicate the network resource with the network user includes logic adapted to retrieve the cached network resource and communicate the cached network resource with the network user.

5. The system of claim 3, wherein the network preferences include a virtual network associated with the network user.

6. The system of claim 3, wherein the network preferences include an identifier associated with a previously requested network resource.

7. The system of claim 3, wherein the network preferences include a search term provided by the network user to a search engine.

8. The system of claim 1, wherein the network resource is a web page.

9. The system of claim 1, wherein the logic adapted to determine if an advertisement should be provided includes logic adapted to determine if a time elapsed since a previous advertisement is greater than an advertising time period value associated with the network user and logic adapted to indicate that an advertisement should be provided in response to the determination that the time elapsed since the previous advertisement is greater than the advertising time period value

10. The system of claim 1, wherein the advertisement includes a web page.

11. The system of claim 10, wherein the logic adapted to detect the termination of the advertisement includes logic adapted to receive an indicator generated by program code in the web page at the termination of the advertisement.

12. The system of claim 3, further comprising a local data storage device adapted to store the stored set of advertisements.

13. The system of claim 3, wherein the stored set of advertisements includes a public service announcement.

14. The system of claim 1, wherein the network interface is adapted to use a wireless network connection in the local area network.

15. The system of claim 1, further comprising:
logic adapted to embed the advertisement in the network resource.

16. The system of claim 1, wherein the advertisement includes a commercial adapted to be presented to the user prior to the network resource.

17. The system of claim 16, wherein the commercial includes video.

18. The system of claim 1, wherein the advertisement is network resource independent.
